(19) United States
(12) Patent Application Publication
(10) Pub. No.: US 2019/0126703 A1
(43) Pub. Date: May 2, 2019

(54) Control Arm Bearing and Method of Making

(71) Applicant: Federal-Mogul Motorparts LLC, Southfield, MI (US)

(72) Inventors: Ahmet Gonul, Dendermonde (TR); Sidney Paeweryck, Aalst (BE)

(21) Appl. No.: 16/171,799

(22) Filed: Oct. 26, 2018

Related U.S. Application Data
(60) Provisional application No. 62/577,900, filed on Oct. 27, 2017.

(51) Int. Cl. B60G 7/00; B60G 3/20; F16C 19/38; F16C 19/18

(52) U.S. Cl. CPC B60G 7/001; B60G 3/20; F16C 19/38; B60G 2204/418; B60G 2204/41; B60G 2206/10; F16C 2326/05; F16C 19/18

(57) ABSTRACT

The control arm bushing assembly includes an inner race that has a cylindrical shape and extends along a central axis between opposite ends. An outer race, which has a cylindrical shape and is disposed radially outwardly of the inner race, extends along the central axis between opposite ends that are generally aligned with the opposite ends of the inner race. A plurality of rolling elements are disposed between and in contact with the inner and outer races for allowing the inner and outer races to freely rotate about the central axis relative to one another. The inner race presents an open bore which extends along the central axis for receiving a fastener. At least two cushioning rings surround the outer race and are made of an elastomeric material.

### CROSS REFERENCE TO RELATED APPLICATIONS

This U.S. patent application claims the benefit of U.S. Provisional Patent Application Ser. No. 62/577,900 filed Oct. 27, 2017 entitled “Control Arm Bearing and Method of Making,” the entire disclosure of the application being considered part of the disclosure of this application and hereby incorporated by reference.

### BACKGROUND OF THE INVENTION

### 1. Field of the Invention

The present invention is related generally to a control arm assembly for a vehicle suspension system and, more particularly, to a bushing of a control arm assembly.

### 2. Related Art

In many vehicle suspension systems, a control arm is operatively attached with a vehicle frame in such a manner that the control arm is able to articulate relative to the frame when a wheel of the vehicle encounters an obstacle (such as a pot hole) or when a body of the vehicle rolls while the vehicle is cornering at speed. To facilitate this articulation, such control arms typically include one or more horizontal bushings. One known design of a control arm bushing includes two hard surfaces that are in sliding contact with one another.

### SUMMARY OF THE INVENTION AND ADVANTAGES

One aspect of the present invention is related to a control arm bushing assembly which includes an inner race that has a cylindrical shape and extends along a central axis between opposite ends. An outer race, which has a cylindrical shape and is disposed radially outwardly of the inner race, extends along the central axis between opposite ends that are generally aligned with the opposite ends of the inner race. A plurality of rolling elements are disposed between and in contact with the inner and outer races for allowing the inner and outer races to freely rotate about the central axis relative to one another. The inner race presents an open bore which extends along the central axis for receiving a fastener. At least two cushioning rings surround the outer race and are made of an elastomeric material.

The improved bushing advantageously allows a control arm to more freely pivot relative to a vehicle frame with lower friction as compared to other known control arm bushings. In addition to improving vehicle dynamics, this reduction in friction as the control arm pivots reduces heat generation during operation of the vehicle and increases the durability and operating life of the bushing assembly. Moreover, as discussed in further detail below, the bushing assembly can be manufactured very cost effectively and can be installed in a control arm body very quickly and easily.

According to another aspect of the present invention, each of the cushioning rings has an axial portion and a flange portion that extends radially outwardly from the axial portion.

According to yet another aspect of the present invention, the at least two cushioning rings are identical in shape with one another.

According to still another aspect of the present invention, the opposite ends of at least one of the inner and outer races have flanges for capturing the rolling elements between the inner and outer races.

According to a further aspect of the present invention, the rolling elements are needle rollers.

According to yet a further aspect of the present invention, the rolling elements are ball bearings.

Another aspect of the present invention is related to a control arm assembly with a control arm body that has at least one opening. A bushing is disposed in the opening, and the bushing has an inner race that has a cylindrical shape and that extends along a central axis between opposite ends. The bushing also has an outer race that is cylindrical in shape and that is disposed radially outwardly of the inner race. The outer race extends along the central axis between opposite ends that are generally aligned with the opposite ends of the inner race. A plurality of rolling elements are disposed between and in contact with the inner and outer races for allowing the inner and outer races to freely rotate about the central axis relative to one another. The inner race presents an open bore which extends along the central axis for receiving a fastener. At least two cushioning rings surround the outer race and are made of an elastomeric material and are in direct contact with the control arm body.

Another aspect of the present invention is related to a method of repairing a control arm assembly. The method includes the step of removing a previously used bushing from an opening in a control arm body. The method proceeds with the step of inserting a pre-assembled bearing that includes an inner race, an outer race, and a plurality of rolling elements into the opening and inserting a first cushioning ring that is made of an elastomeric material into the opening from a first side of the opening such that the first cushioning ring is in direct contact with an inner wall of the control arm body. The method continues with the step of inserting a second cushioning ring into the opening of the control arm body from a second side of the opening opposite of the first side of the opening.

According to another aspect of the present invention, each of the cushioning rings has an axial portion and a flange portion which extends radially outwardly from one end of the axial portion.

According to yet another aspect of the present invention, the cushioning rings are identical in shape with one another.

### BRIEF DESCRIPTION OF THE DRAWINGS

These and other features and advantages of the invention will become more readily appreciated when considered in connection with the following description of the presently preferred embodiments, appended claims and accompanying drawings, in which:

FIG. 1 is a perspective elevation view of an exemplary embodiment of a control arm assembly constructed according to one aspect of the present invention;

FIG. 2 is an exploded view of a first exemplary embodiment of a bushing of the control arm assembly of FIG. 1;

FIG. 3 is a cross-sectional view of the bushing of FIG. 2 shown installed in a control arm body and in a vehicle frame;

FIG. 4 is a front elevation view of the bushing of FIG. 2 in an installed condition and with a seal removed to expose a plurality of rolling elements;

FIG. 5 is an exploded view of a second exemplary embodiment of the bushing;

FIG. 6 is a perspective and sectional view of the second exemplary embodiment of the bushing; and

FIG. 7 is a cross-sectional view of the second exemplary embodiment of the bushing.

### DESCRIPTION OF THE ENABLING EMBODIMENT

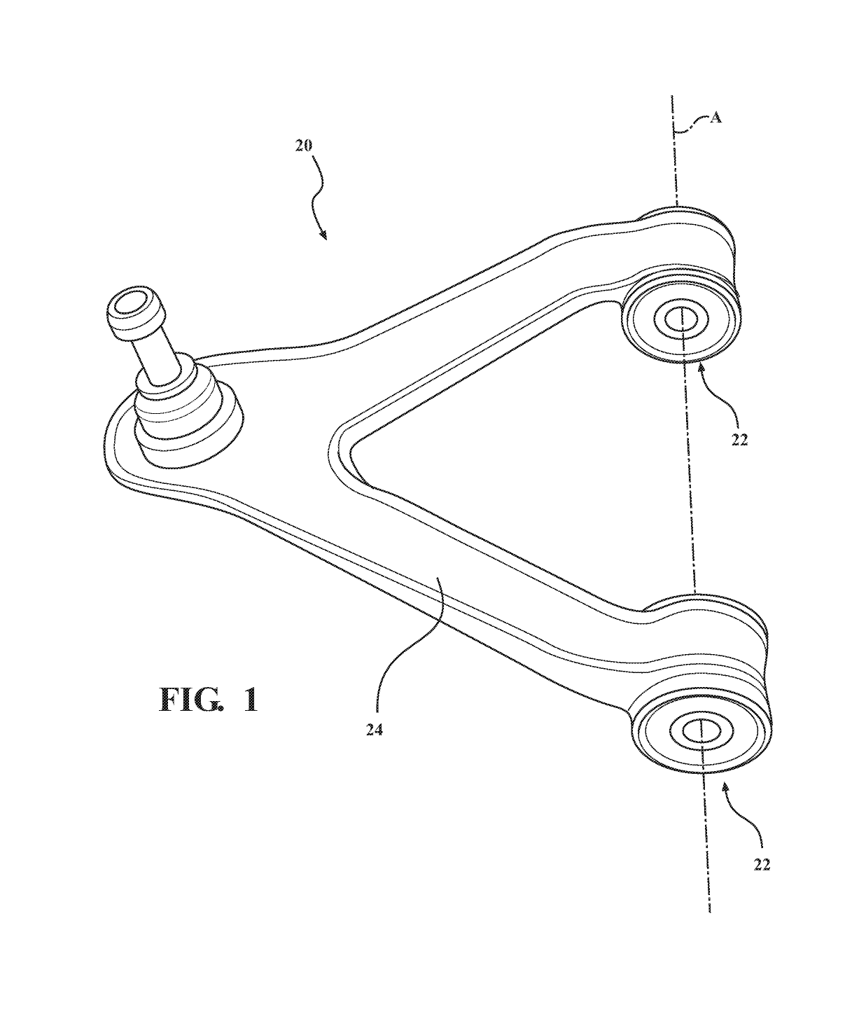

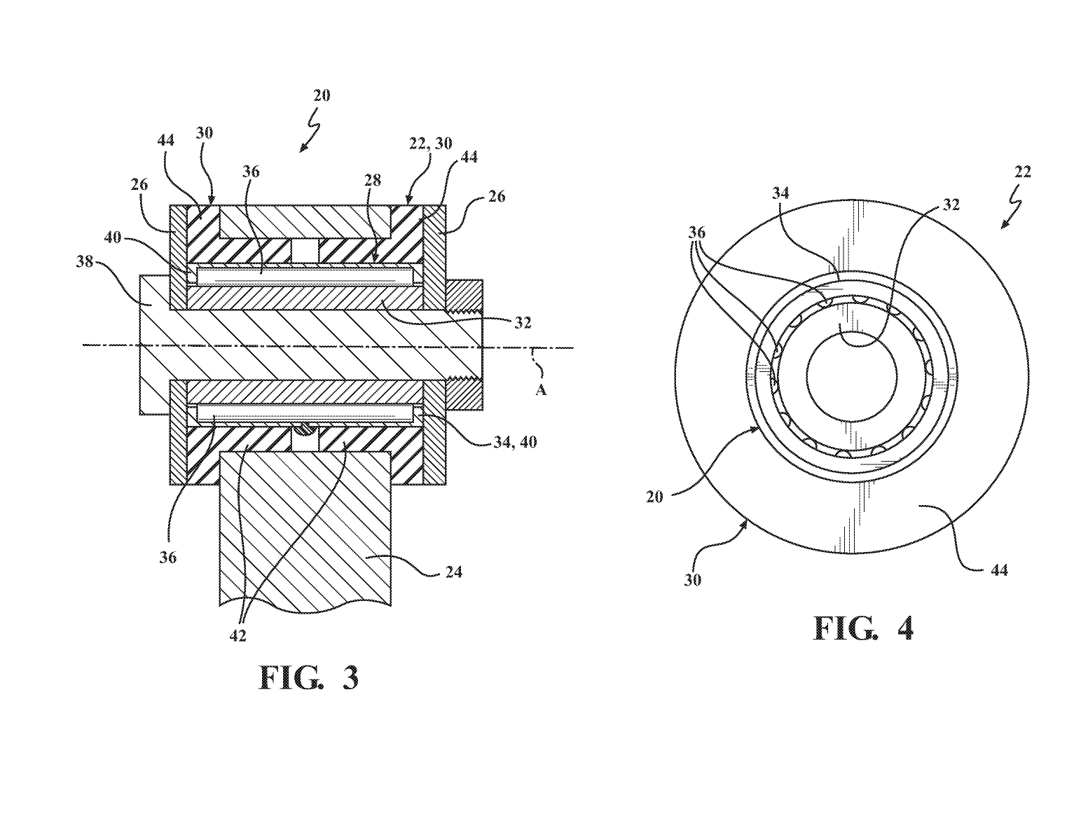

Referring to FIG. 1, wherein like numerals indicate corresponding parts throughout the several views, a control arm assembly 20 with a first exemplary embodiment of an improved horizontal bushing 22, which is constructed according to one aspect of the present invention, is generally shown. The control arm assembly 20 includes a control arm body 24 which has an opening that receives the bushing 22 to interconnect the control arm body 24 with a vehicle frame 26 (shown in FIG. 3). In operation, the bushing 22 allows the control arm body 24 to articulate relative to the vehicle frame 26 with lower frictional losses as compared to other known bushing assemblies when a wheel of the vehicle contacts an obstacle (such as a pot hole) or as a body of the vehicle rolls during cornering. In the exemplary embodiment of FIG. 1, the control arm assembly 20 includes two horizontal bushings 22 that are co-axially aligned with one another along a single horizontally oriented central axis A. However, it should be appreciated that in some applications, only one horizontal bushing 22 may be provided.

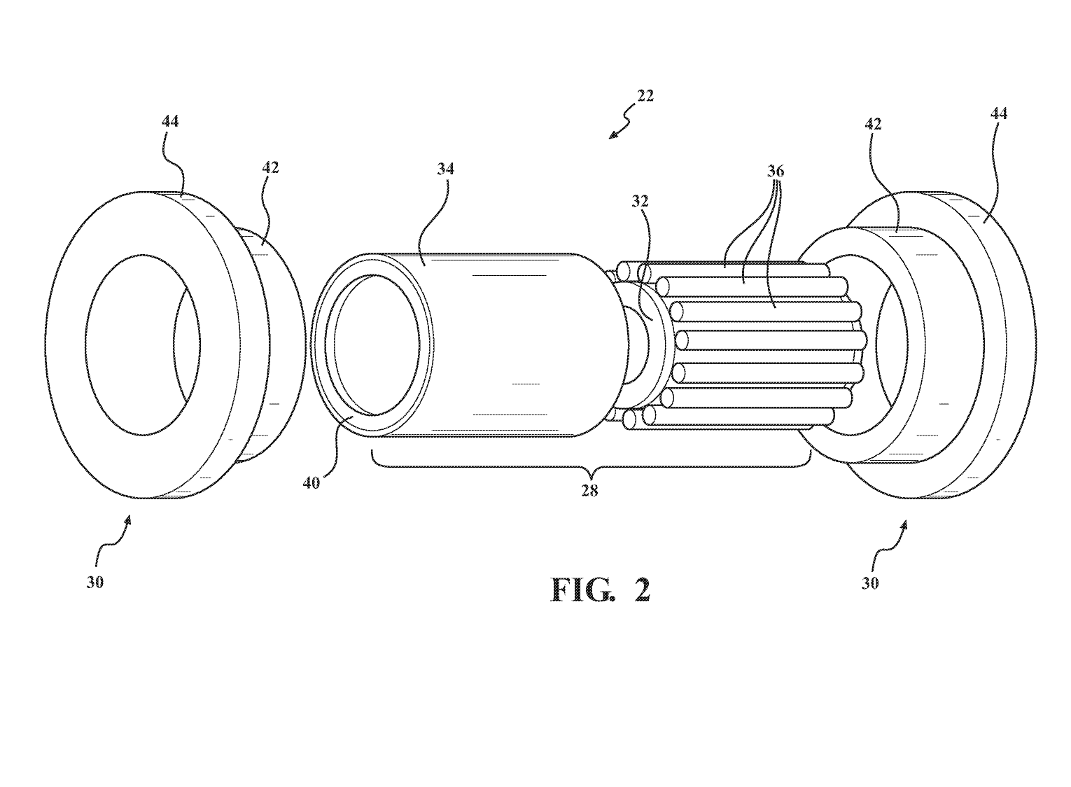

Referring now to FIGS. 2-4, the first exemplary embodiment of the bushing 22 includes a single bearing 28 and a pair of cushioning rings 30. The bearing 28 has an inner race 32, an outer race 34, and a plurality of rolling elements 36. The inner race 32 is tubular in shape and extends along the central axis A between opposite open ends. The inner race 32 presents an inner bore which extends between the opposite open ends to receive a bolt 38, or any suitable type of fastener, which operatively connects the bearing 28 with the vehicle frame 26. The inner race 32 also has an outer surface that is generally cylindrical in shape and against which the rolling elements 36 directly roll. The inner race 32 is preferably made as a single piece of metal, such as stainless steel, and has a length which is greater than a length of the opening in the control arm body 24 such that, when the bushing 22 is installed in the control arm body 24, the inner race 32 extends out of the opening on both sides of the control arm body 24.

In the first exemplary embodiment, the outer race 34 is constructed as a monolithic piece of metal which has a length that is similar to the inner race 32. The outer race 34 is also generally tubular in shape but has an end flange 40, which extends radially inwardly towards the inner race 32, at each of its axial ends. Neighboring end faces of the inner and outer races 32, 34 are generally flush with one another. When the bearing 28 is assembled, the end flanges 40 of the outer race 34 capture the rolling elements 36 between the inner and outer races 32, 34. The outer race 34 is provided with a lubricant opening for injecting a lubricant between the inner and outer races 34.

In the first embodiment, the rolling elements 36 are needle bearings in that they are generally cylindrical in shape. The rolling elements 36 are spaced circumferentially from one another around the inner race and, in operation, roll along the inner and outer races 32, 34, thereby allowing the inner and outer races 32, 34 to freely rotate relative to one another about the central axis A with minimal friction losses. As discussed in further detail below, the bearing 28 provides a very low friction interface between the control arm body 24 and the vehicle frame 26 which improves the driving dynamics of the vehicle. As compared to other known bushings which rely on a sliding interface between two hard surfaces to facilitate the pivoting movement of the control arm body 24 relative to the vehicle frame 26, the low friction interface provided by the bearing 28 of the exemplary embodiment also reduces energy consumption and heat generation as the control arm body 24 pivots relative to the vehicle frame 26.

The cushioning rings 30 surround the outer race 34 and separate the outer race 34 from the vehicle frame 26. That is, when the bushing 22 is installed in the control arm body 24 and fixedly attached with the vehicle frame 26, there is no direct contact between the outer race 34 and the vehicle frame 26. Each of the cushioning rings 30 has an axial portion 42 that is generally cylindrical in shape and a flange portion 44 that extends radially outwardly at one end of the axial portion 42.

The cushioning rings 30 are made of an elastomeric material (such as rubber or a synthetic rubber-like material) which can compress to absorb energy in response to radial impact forces between the vehicle frame 26 and the control arm body 24 to protect the bearing 28 from damage. Thus, the cushioning rings 30 improve the durability and operating life of the control arm assembly 20. The material chosen for the cushioning rings 30 can be selected to have a desired elasticity to provide the control arm assembly 20 with a desirable amount of cushioning. Thus, the radial stiffness of the control arm assembly 20 can be adjusted by simply changing the material of the cushioning rings 30. A harder material will result in a greater radial stiffness, and a softer material will result in a lesser radial stiffness. Also, cushioning rings 30 that have different thicknesses in their axial portions 42 can be employed to all the same bearing 28 to be used with control arm bodies that have differently sized openings. Thus, the bushing 22 can be tailored for use with different vehicles by selecting the appropriate cushioning rings 30.

When the bushing 22 is installed into the control arm body 24, the cushioning rings are in a press-fitting engagement with both the outer race 34 and the opening of the control arm body 24. Thus, during operation of the vehicle, the cushioning rings 30 and the outer race remain stationary with the vehicle frame 26 while the inner race 32, bolt 38, and control arm body 24 pivot about the central axis A. The cushioning rings 30 are preferably identical to one another in construction to allow for cost savings through economies of scale. The cushioning rings 30 are preferably made through an injection molding operation.

As shown in FIG. 3, when the bushing 22 is installed in the control arm body 24, the flange portions 44 of the cushioning rings 30 overly opposite outer faces of the control arm body 24. Further, as referenced in FIG. 3, neighboring end faces of the axial portions 42 of the cushioning rings 30 are spaced from one another in the axial direction by a gap.

Installation of the bushing 22 into a control arm body 24 begins with a pre-assembled bearing 28. One of the cushioning rings 30 is then inserted onto the outer race 34 of the bearing 28. Next, the bearing 28 with the single cushioning ring 30 is inserted into the opening of the control arm body 24 from one side until the flange portion 44 of the cushioning ring 30 contacts an outer face of the control arm body 24. Then, the other cushioning ring 30 is inserted into the opening from the other side of the control arm body 24 until its flange portion 44 contacts the other outer face of the control arm body 24.

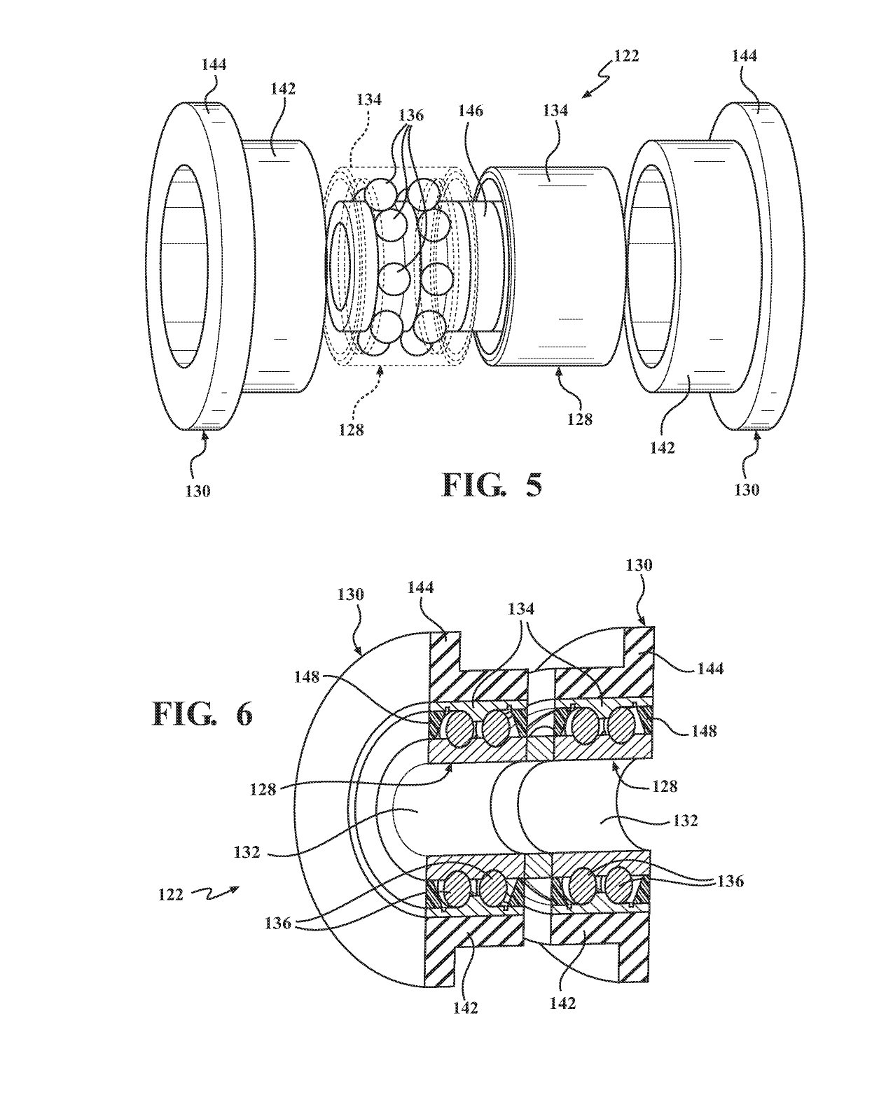

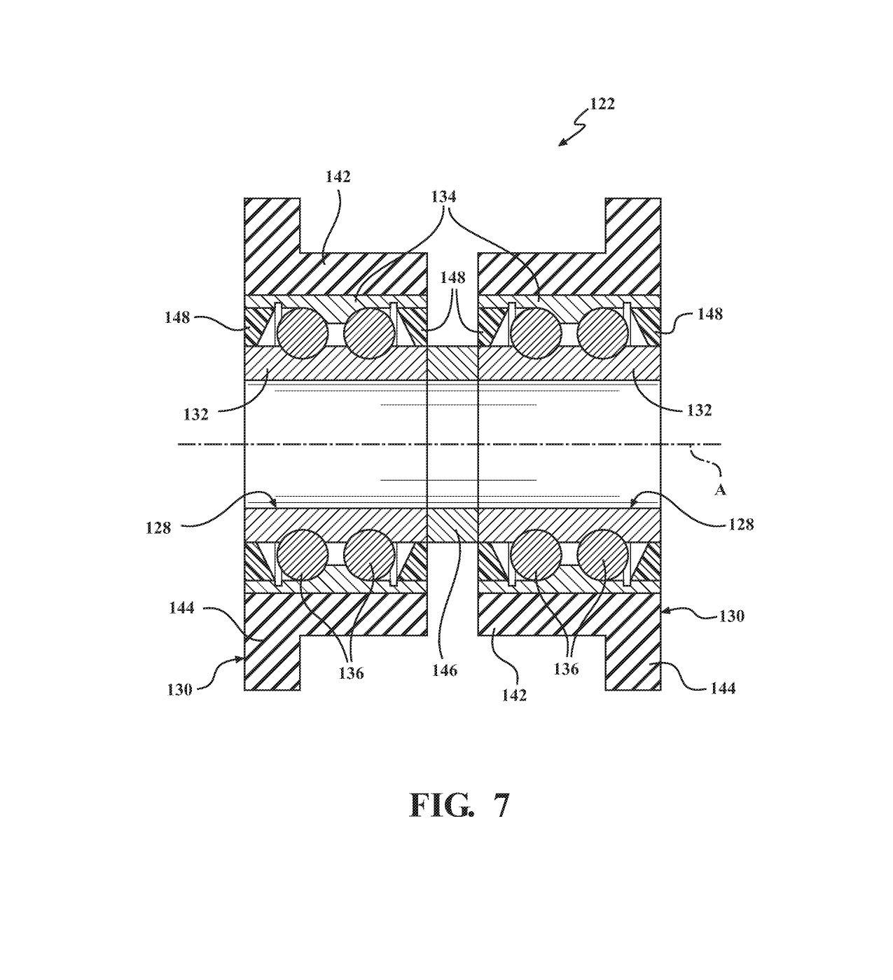

Referring now to FIG. 5-7, a second exemplary embodiment of the bushing 122 is generally shown with like numerals, separated by a prefix of “1” identifying corresponding components with the first exemplary embodiment described above. In contrast to the first embodiment, in the second embodiment, the bushing 122 includes two bearings 128, each of which has a respective inner race 132, an outer race 134, and a plurality of rolling elements 136 in the form of spherical ball bearings 136. Specifically, in this embodiment, each of the bearings 128 has two rows of spherical ball bearings 136 to facilitate low friction rotation of the inner and outer races 132, 134 relative to one another. In this embodiment, the two bearings 128 are separated from one another by a spacer 146 which abuts neighboring end faces of the two inner races 132. In this embodiment, the bearings 128 are of identical construction and are symmetrical about a plane that extends perpendicularly to the central axis A. Thus, either bearing 128 can be inserted into either side of the opening of the control arm body 24 (shown in FIG. 1) in either orientation. This allows for reduced costs through economies of scale since the two bearings 128 are of identical construction and through reduced installation time by simplifying the process of installing the bushing 122 in the control arm body 24. Each of the bearings 128 also has a pair of annularly-shaped seals 148 which capture the ball bearings 136 and a lubricant between the inner and outer races 132, 134. Each seal extends between and is in sealing contact with neighboring ends of the inner and outer races 132, 134.

Installation of the second embodiment of the bushing 122 into a control arm body 24 (shown in FIG. 1) begins with pre-assembling both of the bearings 128 and inserting the cushioning rings 130 over the outer races 134. Next, one of the bearings 128, along with its respective cushioning ring 130, is inserted into the opening of the control arm body 24 from one side of the control arm body 24 until the flange portion 144 of the cushioning ring 130 contacts an outer face of the control arm body 24. Then, the spacer 146 and the other bearing 128, along with its respective cushioning ring 130, is inserted into the opening of the control arm body 24 from the other side of the control arm body 24 until its flange portion 144 contacts an outer face of the control arm body 24.

Obviously, many modifications and variations of the present invention are possible in light of the above teachings. It is, therefore, to be understood that within the scope of the appended claims, the invention may be practiced otherwise than specifically described. Additionally, it is to be understood that all features of all claims and all embodiments can be combined with each other, as long as they do not contradict each other.

What is claimed is:

1. A control arm bushing assembly, comprising:
an inner race having a cylindrical shape and extending along a central axis between opposite ends;
an outer race having a cylindrical shape and disposed radially outwardly of said inner race, said outer race extending along said central axis between opposite ends that are generally aligned with said opposite ends of said inner race;
a plurality of rolling elements disposed between and in contact with said inner and outer races for allowing said inner and outer races to freely rotate about said central axis relative to one another;
said inner race presenting an open bore which extends along said central axis for receiving a fastener; and
at least two cushioning rings surrounding said outer race and being made of an elastomeric material.

2. The control arm bushing assembly as set forth in claim 1 wherein each of said cushioning rings has an axial portion and a flange portion that extends radially outwardly from said axial portion.

3. The control arm bushing assembly as set forth in claim 2 wherein said at least two cushioning rings are identical in shape with one another.

4. The control arm bushing assembly as set forth in claim 1 wherein said opposite ends of at least one of said inner and outer races have flanges for capturing said rolling elements between said inner and outer races.

5. The control arm bushing assembly as set forth in claim 1 wherein said rolling elements are needle rollers.

6. The control arm bushing assembly as set forth in claim 1 wherein said rolling elements are ball bearings.

7. A control arm assembly, comprising:
a control arm body having at least one opening; and
a bushing disposed in said opening, said bushing including;
an inner race having a cylindrical shape and extending along a central axis between opposite ends,
an outer race having a cylindrical shape and disposed radially outwardly of said inner race, said outer race extending along said central axis between opposite ends that are generally aligned with said opposite ends of said inner race,
a plurality of rolling elements disposed between and in contact with said inner and outer races for allowing said inner and outer races to freely rotate about said central axis relative to one another,
said inner race presenting an open bore which extends along said central axis for receiving a fastener, and
at least two cushioning rings surrounding said outer race and being made of an elastomeric material and being in direct contact with said control arm body.

8. The control arm bushing assembly as set forth in claim 7 wherein each of said cushioning rings has an axial portion and a flange portion that extends radially outwardly from said axial portion.

9. The control arm assembly as set forth in claim 8 wherein said at least two cushioning rings are identical in shape with one another.

10. The control arm assembly as set forth in claim 7 wherein said opposite ends of at least one of said inner and outer races have flanges for capturing said rolling elements between said inner and outer races.

11. The control arm assembly as set forth in claim 7 wherein said rolling elements are needle rollers.

12. The control arm assembly as set forth in claim 7 wherein said rolling elements are ball bearings.

13. A method of repairing a control arm assembly, comprising the steps of:
removing a previously used bushing from an opening in a control arm body;
inserting a pre-assembled bearing that includes an inner race, an outer race, and a plurality of rolling elements into the opening and inserting a first cushioning ring that is made of an elastomeric material into the opening from a first side of the opening such that the first cushioning ring is in direct contact with an inner wall of the control arm body; and
inserting a second cushioning ring into the opening of the control arm body from a second side of the opening opposite of the first side of the opening.

14. The method as set forth in claim 13 wherein each of the cushioning rings has an axial portion and a flange portion which extends radially outwardly from one end of the axial portion.

15. The method as set forth in claim 13 wherein the cushioning rings are identical in shape with one another.
